(19) United States
(12) Patent Application Publication
(10) Pub. No.: US 2019/0193695 A1
(43) Pub. Date: Jun. 27, 2019

(54) VEHICLE BRAKING DEVICE

(71) Applicants: ADVICS CO., LTD., Kariya-shi, Aichi-ken (JP); TOYOTA JIDOSHA KABUSHIKI KAISHA, Toyota-shi, Aichi-ken (JP)

(72) Inventors: Masaki NINOYU, Gamagori-shi, Aichi-ken (JP); Yusuke KAMIYA, Okazaki-shi, Aichi-ken (JP)

(73) Assignees: ADVICS CO., LTD., Kariya-shi, Aichi-ken (JP); TOYOTA JIDOSHA KABUSHIKI KAISHA, Toyota-shi, Aichi-ken (JP)

(21) Appl. No.: 16/303,437

(22) PCT Filed: May 22, 2017
(86) PCT No.: PCT/JP2017/019018

§ 371 Date: Nov. 20, 2018

(30) Foreign Application Priority Data
May 27, 2016 (JP) 2016-106609

(51) Int. Cl. B60T 8/1761; B60T 13/14; B60T 8/88; B60T 17/22

(52) U.S. Cl. CPC B60T 8/1761; B60T 13/142; B60T 2270/14; B60T 17/222; B60T 2210/12; B60T 8/885

(57) ABSTRACT

A vehicle braking device of a by-wire type includes an actuator configured to flow out a fluid in a subject wheel cylinder among the plurality of wheel cylinders to flow towards the master chamber upon pressure decreasing control for the subject wheel cylinder under an ABS control execution and a control portion executing a first control controlling the driving portion such that an increasing amount of the master pressure under a pressure increasing control becomes great or a decreasing amount thereof under a pressure decreasing control becomes small and/or executes a second control which controls the driving portion such that the increasing amount of the master pressure under the pressure increasing control becomes small or the decreasing amount thereof under the pressure decreasing control of the master pressure becomes great.

### TECHNICAL FIELD

This invention relates to a vehicle braking device.

### BACKGROUND ART

In a vehicle braking device, there is a by-wire type vehicle braking device in which the hydraulic pressure (master pressure) of the master chamber provided in the master cylinder is adjusted and/or controlled independently of the operation of the brake operating member. Further, in a generally used vehicle braking device, a common master chamber (in a case where a plurality of master chambers is provided, this case can be also referred to as one common master chamber, as long as these chambers are mechanically inter-connected to one another) is connected to a plurality of wheel cylinders. Further, in a vehicle braking device, an actuator is provided between the master chamber and the wheel cylinders. The actuator executes an ABS control depending on the vehicle running situation and in the pressure decreasing control during the ABS control, the fluid in the wheel cylinders returns to the master chamber side. Such vehicle braking device is shown in, for example, a patent publication No. JP 2015-143060 A.

### CITATION LIST

### Patent Literature

[Patent Literature 1] JP 2015-143060 A

### SUMMARY OF INVENTION

### Technical Problem(s)

However, according to the vehicle braking device as explained above, when the ABS control is executed at only some of the plurality of vehicle wheels, the fluid flows in or flows out of the common master chamber as a result of pressure decreasing control or the pressure increasing control during the ABS control and such ABS control transitionally influences on the wheel cylinders at which the ABS control is not executed. For example, during an ABS control executed at a first vehicle wheel, when the ABS control is shifted from the pressure decreasing control to the pressure increasing control, the pressure (wheel cylinder pressure) in the wheel cylinder corresponding to the first vehicle wheel may be possibly reduced to a value smaller than the wheel cylinder pressures in the other wheel cylinders of corresponding other vehicle wheels. Under such situation, a relatively large amount of fluid flows into the wheel cylinder of the first vehicle wheel from the common master chamber. Due to such flow of the fluid into the wheel cylinder of the first vehicle wheel, the master pressure drops temporarily to a value lower than the expected value, which may cause a delay of rising of braking force at the vehicle wheels other than the first vehicle wheel. In other words, this may create an imbalance of applied braking force between the first vehicle wheel and other vehicle wheels. Thus, the above explained conventional vehicle braking device has still a room for improvements with respect to the stability of vehicle behavior.

Particularly in a by-wire type vehicle braking device, the fluctuations of master pressure derived from the ABS control executed at some of the plurality of vehicle wheels is not transmitted to the brake operating member and accordingly, such fluctuations of the master pressure is not absorbed by the movement of the brake operating member. The fluctuations of the master pressure influence on the wheel cylinder pressure and eventually influence on the braking force.

The present invention was made in consideration with the above problems and the objective of the invention is to provide a vehicle braking device which suppress the fluctuations of master pressure derived from the ABS control executed only at some of the vehicle wheels.

### Solution to Problem(s)

The vehicle braking device according to the invention is characterized in that the vehicle braking device is a by-wire type vehicle braking device which includes a master cylinder having a master piston and a master chamber which volume is changed in response to a movement of the master piston, a driving portion which drives the master piston to adjust a master pressure which is a pressure of the master chamber independently of an operation of a brake operating member, an actuator provided in a hydraulic passage connecting the master chamber and a plurality of wheel cylinders for adjusting a hydraulic pressure in each of the plurality of wheel cylinders and a control portion which controls the driving portion and the actuator, wherein the actuator is configured to flow out a fluid in a pressure decreasing subject wheel cylinder among the plurality of wheel cylinders to flow towards the master chamber upon pressure decreasing control for the pressure decreasing subject wheel cylinder under an ABS control execution when the ABS control is executed by the control portion; and under the ABS control being executed at only one or some of a plurality of vehicle wheels corresponding to the plurality of wheel cylinders, the control portion executes a first control which controls the driving portion such that if an out-flow liquid amount of the fluid per unit time from the master chamber is greater than a predetermined out-flow amount, an increasing amount of the master pressure per unit time under a pressure increasing control of the master pressure becomes great or a decreasing amount of the master pressure per unit time under a pressure decreasing control of the master pressure becomes small, compared to a case where the out-flow liquid amount is equal to or less than the predetermined out-flow amount and/or the control portion executes a second control which controls the driving portion such that if an in-flow liquid amount of the fluid per unit time into the master chamber is greater than a predetermined in-flow amount, the increasing amount of the master pressure per unit time under the pressure increasing control of the master pressure becomes small or the decreasing amount of the master pressure per unit time under the pressure decreasing control of the master pressure becomes great, compared to a case where the in-flow liquid amount is equal to or less than the predetermined in-flow amount.

### Effect of Invention

According to the invention, for example, a transitional rising of the master pressure due to a circulation of the fluid to the master chamber side upon pressure decreasing control under the ABS control can be suppressed by suppressing the increase of the master pressure or by accelerating the decrease thereof by the execution of the second control. Further, according to the invention, for example, a transitional decrease of the master pressure due to an increase of in-flow fluid into the ABS control subject wheel cylinder can be suppressed by suppressing the decrease of the master pressure or by accelerating the increase thereof by the execution of the first control. Thus, according to the invention, the fluctuations of the master pressure derived from the ABS control for one or some of the vehicle wheels can be suppressed.

### BRIEF EXPLANATION OF ATTACHED DRAWINGS

FIG. 1 is a structural view of a vehicle braking device according to an embodiment of the invention;

FIG. 2 is an explanatory view explaining a behavior of a vehicle;

FIG. 3 is a time chart explaining the first control and the second control of the embodiment: and

FIG. 4 is a flowchart explaining the first control and the second control of the embodiment.

### EMBODIMENTS FOR IMPLEMENTING INVENTION

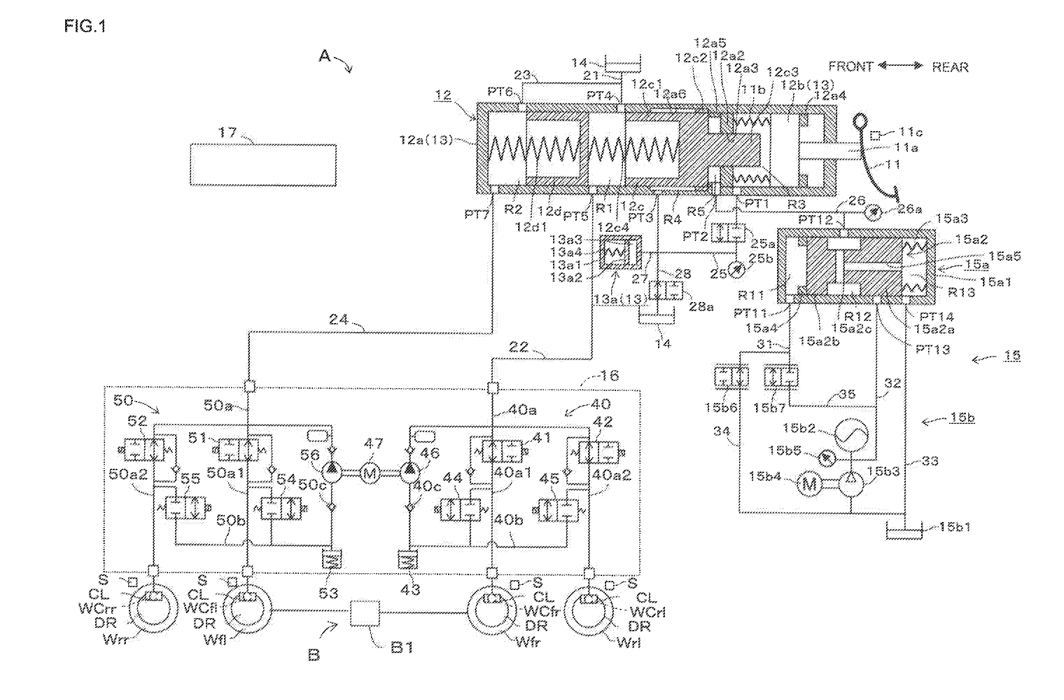

The invention of the vehicle device according to one embodiment of the invention adapted to a vehicle will be explained hereinafter with reference to the attached drawings. The vehicle is equipped with a vehicle braking device A which applies hydraulic pressure braking force directly to each vehicle wheel Wfl, Wfr, Wrl and Wrr (in some case, collectively referred to as vehicle wheel “W”, front wheel “Wf” and rear wheel “Wr”) to apply brakes to the vehicle. The vehicle of the embodiment is a hybrid type vehicle with front wheel drive and is equipped with a regeneration braking device B which generates a regeneration braking force at the front wheel Wf. The regeneration braking device B includes a generator B1 (B1 in FIG. 1) provided at the drive shaft of the front wheel Wf. It is noted here that although no illustration is shown in the drawings, the regeneration braking device B includes a hybrid ECU, a battery and an inverter. The regeneration braking device B generates the regeneration braking force which is obtained by converting the kinetic energy of the vehicle to the electric energy and applies the regeneration braking force to the wheel W (here in this embodiment, front wheel Wf). The operation of such regeneration braking device is well known and the detail explanation thereof is omitted.
(Overall Structure)

The vehicle braking device A includes a brake pedal 11, a master cylinder 12, a stroke simulator portion 13, a reservoir 14, a booster mechanism (corresponding to the “driving portion”) 15, an actuator 16, a brake ECU (corresponding to the “control portion”) 17 and wheel cylinders WC, as shown in FIG. 1.

The wheel cylinders WCfl, WCfr, WCrl and WCrr (hereinafter collectively referred to as wheel cylinder WC) restrict the rotation of the wheel W and are disposed in the respective calipers CL. The wheel cylinder WC serves as a braking force applying mechanism which applies braking force to the wheel W of the vehicle based on the pressure (brake hydraulic pressure) of the brake liquid (corresponding to “fluid”) from the actuator 16. When the brake hydraulic pressure is supplied to the wheel cylinder WC, each piston (not shown) in each wheel cylinder WC pushes a pair of brake pads (not shown) which serves as friction members and squeezes a disc rotor DR which serves as a rotational member rotating unitary with the wheel W from both sides thereof to thereby restrict the rotation of the rotor DR. It is noted here that in this embodiment, a disc type brake device is used but a drum type brake device may be used.

The brake pedal 11 corresponds to the brake operating member and is connected to the stroke simulator portion 13 and the master cylinder 12 via an operation rod 11a. A stroke sensor 11c which detects a brake pedal stroke (operating amount: hereinafter, in some cases, referred to simply as “stroke”) by depression of the brake pedal 11, which is under a braking operation state, is provided in the vicinity of the brake pedal 11. The stroke sensor 11c is connected to the brake ECU 17 and the detected signal (detection result) is outputted to the brake ECU 17.

The master cylinder 12 supplies the actuator 16 with the brake liquid in response to the operating amount of the brake pedal 11 and the master cylinder 12 is formed by a cylinder body 12a, an input piston 12b, a first master piston 12c and a second master piston 12d, etc.

The cylinder body 12a is formed in a substantially bottomed cylinder shape housing having a bottom surface closed. The cylinder body 12a includes therein a partition wall portion 12a2 which extends inwardly with a shape of flange at the inner peripheral portion. An inner circumferential surface of the partition wall portion 12a2 is provided with a through hole 12a3 at a central portion thereof, penetrating through the partition wall portion 12a2 in a front/rearward direction. The cylinder body 12a is provided with a first master piston 12c and a second master piston 12d at an inner peripheral portion thereof at a portion further front side than the partition wall portion 12a2. The first master piston 12c and the second master piston 12d are provided to be liquid-tightly movable in an axial direction in the cylinder body 12a.

The cylinder body 12a is provided with an input piston 12b at an inner peripheral portion thereof at a portion further rear side than the partition wall portion 12a2. The input piston 12b is liquid-tightly movable in an axial direction in the cylinder body 12a. The input piston 12b slidably moves within the cylinder body 12a in response to the operation of the brake pedal 11.

The operation rod 11 a which is operable in association with the movement of the brake pedal 11 is connected to the input piston 12b. The input piston 12b is biased in a direction where the volume of the first hydraulic pressure chamber R3 becomes large, i.e., in a rearward direction (right direction as viewed in the drawing) by means of a compression spring 11b. When the brake pedal 11 is depressed, the operation rod 11a advances forward overcoming the biasing force of the compression spring 11b. By this advance movement of the operation rod 11a, the input piston 12b advances in association with the movement of the operation rod 11a. When the depression operation of the brake pedal 11 is released, the input piston 12b retreats by the biasing force of the compression spring 11b and is brought into contact with a restriction projecting portion 12a4 for positioning the input piston thereat.

The first master piston 12c includes a pressurizing cylindrical portion 12c1, a flange portion 12c2 and a projecting portion 12c3 in order from the front side and these portions 12c1, 12c2 and 12c3 are formed integrally as a unit. The pressurizing cylindrical portion 12c1 is formed in a substantially bottomed cylinder shape having an opening at a front portion thereof and a bottom wall at a rear portion thereof. The pressurizing cylindrical portion 12c1 is liquid-tightly movably provided in the inner peripheral surface of the cylinder body 12a. A coil spring-shaped biasing member 12c4 is provided in the inner space of the pressurizing cylindrical portion 12c1 between the first master piston 12c and the second master piston 12d. The first master piston 12c is biased in a rearward direction by the coil spring 12c4. In other words, the first master piston 12c is biased by the coil spring 12c4 in a rearward direction and is finally brought into contact with a restriction projecting portion 12a5 for positioning. This position is defined to be the initial position (position predetermined in advance) at the time the depression operation of the brake pedal 11 is released.

The flange portion 12c2 is formed to have a greater diameter than the diameter of the pressurizing cylindrical portion 12c1 and is liquid-tightly and slidably disposed on an inner peripheral surface of a large diameter portion 12a6 in the cylinder body 12a. The projecting portion 12c3 is formed to have a smaller diameter than the diameter of the pressurizing cylindrical portion 12c1 and is slidably and liquid-tightly fitted in the through hole 12a3 of the partition wall portion 12a2. The rear end of the projecting portion 12c3 projects into an inner space of the cylinder body 12a, passing through the through hole 12a3 and is separated from the inner peripheral surface of the cylinder body 12a. The rear end surface of the projecting portion 12c3 is separated from the bottom surface of the input piston 12b and the separation distance therebetween is formed to be variable.

The second master piston 12d is arranged in the cylinder body 12a at a front side of the first master piston 12c. The second master piston 12d is formed in a substantially bottomed cylinder shape having an opening at a front portion thereof. A coil spring 12d1 which serves as a biasing member is disposed in the inner space of the second master piston 12d between the second piston 12d and an inner bottom surface of the cylinder body 12a. The second master piston 12d is biased by the coil spring 12d1 in a rearward direction. In other words, the second master piston 12d is biased by the coil spring 12d1 towards a predetermined initial position.

The master cylinder 12 is formed by a first master chamber R1, a second master chamber R2, a first hydraulic pressure chamber R3, a second hydraulic pressure chamber R4 and a servo chamber (hydraulic pressure chamber) R5. In the explanation, hereinafter, the first master chamber R1 and the second master chamber R2 may be collectively referred to as master chambers R1 and R2. The first master chamber R1 is defined by the inner peripheral surface of the cylinder body 12a, the first master piston 12c (front side of the pressurizing cylindrical portion 12c1) and the second master piston 12d. The first master chamber R1 is connected to the reservoir 14 via the hydraulic passage 21 which is connected to the port PT4. Further, the first master chamber R1 is connected to the hydraulic passage 40a (actuator 16) via the hydraulic passage 22 which is connected to the port PT5.

The second master chamber R2 is defined by the inner peripheral surface of the cylinder body 12a and the front side of the second master piston 12d. The second master chamber R2 is connected to the reservoir 14 via the hydraulic passage 23 which is connected to the port PT6. Further, the second master chamber R2 is connected to the hydraulic passage 50a (actuator 16) via the hydraulic passage 24 which is connected to the port PT7.

The first hydraulic pressure chamber R3 is formed between the partition wall portion 12a2 and the input piston 12b and is defined by the inner peripheral surface of the cylinder body 12a, the partition wall portion 12a2, the projecting portion 12c3 of the first master piston 12c and the input piston 12b. The second hydraulic pressure chamber R4 is formed at the side of the pressurizing cylindrical portion 12c1 of the first master piston 12c and is defined by the inner peripheral surface of the large diameter portion 12a6 of the cylinder body 12a, the pressurizing cylindrical portion 12c1 and the flange portion 12c2. The first hydraulic pressure chamber R3 is connected to the second hydraulic pressure chamber R4 via the hydraulic passage 25 which is connected to the port PT1 and the port PT3.

The servo chamber R5 is formed between the partition wall portion 12a2 and the pressurizing cylindrical portion 12c1 of the first master piston 12c and is defined by the inner peripheral surface of the cylinder body 12a, the partition wall portion 12a2, the projecting portion 12c3 of the first master piston 12c and the pressurizing cylindrical portion 12c1. The servo chamber R5 is connected to the output chamber R12 via the hydraulic passage 26 which is connected to the port PT2.

The pressure sensor 26a is a sensor that detects the servo pressure which is supplied to the servo chamber R5 and is connected to the hydraulic passage 26. The pressure sensor 26a sends the detection signal (detection result) to the brake ECU 17. The servo pressure detected by the pressure sensor 26a is an actual value of the hydraulic pressure in the servo chamber R5 and hereinafter this pressure is named as the actual servo pressure (actual hydraulic pressure).

The stroke simulator portion 13 is formed by the cylinder body 12a, the input piston 12b, the first hydraulic pressure chamber R3 and a stroke simulator 13a which is in fluid communication with the first hydraulic pressure chamber R3.

The first hydraulic pressure chamber R3 is in fluid communication with the stroke simulator 13a via the hydraulic passages 25 and 27 which are connected to the port PT1. It is noted that the first hydraulic pressure chamber R3 is in fluid communication with the reservoir 14 via a connection passage (not shown).

The stroke simulator 13a generates a stroke (reaction force) which magnitude depends on the operation state of the brake pedal 11 at the brake pedal 11. The stroke simulator 13a is formed by a cylindrical portion 13a1, a piston portion 13a2, a reaction force hydraulic pressure chamber 13a3 and a spring 13a4. The piston portion 13a2 liquid-tightly slidably moves within the cylindrical portion 13a1 in response to the braking operation which is the operation by the brake pedal 11. The reaction force hydraulic pressure chamber 13a3 is formed between the cylindrical portion 13a1 and the piston portion 13a2 and defined thereby. The reaction force hydraulic pressure chamber 13a3 is in fluid communication with the first hydraulic pressure chamber R3 and the second hydraulic pressure chamber R4 via the connected hydraulic passages 27 and 25. The spring 13a4 biases the piston portion 13a2 in a direction where the volume of the reaction force hydraulic pressure chamber 13a3 decreases.

It is noted that the first electromagnetic valve 25a which is a normally closed type electromagnetic valve is disposed in the hydraulic passage 25. The second electromagnetic valve 28a which is a normally open type electromagnetic valve is disposed in the hydraulic passage 28 which connects the hydraulic passage 25 and the reservoir 14. When the first electromagnetic valve 25a is in a closed state, the fluid communication between the first and the second hydraulic pressure chambers R3 and R4 is interrupted. This fluid communication interruption keeps the constant separation distance between the input piston 12b and the first master piston 12c to allow the coordinative movement therebetween. Further, when the first electromagnetic valve 25a is in an open state, the fluid communication between the first hydraulic pressure chamber R3 and the second hydraulic pressure chamber R4 is established. Thus, the volume change of the first and the second hydraulic pressure chambers R3 and R4 caused by the advance and/or retreat movement of the first master piston 12c can be absorbed by the transfer of the brake liquid.

The pressure sensor 25b is a sensor that detects the reaction force hydraulic pressure in the second hydraulic pressure chamber R4 and the first hydraulic pressure chamber R3 and is connected to the hydraulic passage 25. The pressure sensor 25b also serves as an operating force sensor which detects the operating force to the brake pedal 11 and has a mutual relationship with the operating amount of the brake pedal 11. The pressure sensor 25b detects the pressure in the second hydraulic pressure chamber R4 when the first electromagnetic valve 25a is in a closed state and also detects the pressure (or the reaction force hydraulic pressure) in the first hydraulic pressure chamber R3 which establishes a fluid communication with the second hydraulic pressure chamber R4 when the first electromagnetic valve 25a is in an open state. The pressure sensor 25b sends the detection signal (detection result) to the brake ECU 17.

The booster mechanism 15 generates a servo pressure in response to the operating amount of the brake pedal 11. The booster mechanism 15 is a hydraulic pressure generating device which outputs an output pressure (in this embodiment, the servo pressure) acted by the inputted input pressure (in this embodiment, the pilot pressure) and generates a response delay in which the change of the output pressure relative to the change of the input pressure is delayed at the initial stage of starting of the pressure increasing operation or the pressure decreasing operation when the output pressure is intended to be increasing or decreasing. The booster mechanism 15 includes a regulator 15a and a pressure supply device 15b.

The regulator 15a is configured to have a cylinder body 15a1 and a spool 15a2 which slides in the cylinder body 15a1. The pilot chamber R11, the output chamber R12 and the third hydraulic pressure chamber R13 are formed in the regulator 15a.

The pilot chamber R11 is defined by the cylinder body 15a1 and a front end surface of a second large diameter portion 15a2b of the spool 15a2. The pilot chamber R11 is connected to the pressure decreasing valve 15b6 and the pressure increasing valve 15b7 (hydraulic passage 31) which are connected to the port PT11. A restriction projecting portion 15a4 is provided on the inner peripheral surface of the cylinder body 15a1 to position the spool 15a2 by bringing the second large diameter portion 15a2b into contact with the restriction projecting portion 15a4.

The output chamber R12 is defined by the cylinder body 15a1 and the small diameter portion 15a2c, the rear end surface of the second large diameter portion 15a2b and the front end surface of the first large diameter portion 15a2a of the spool 15a2. The output chamber R12 is connected to the servo chamber R5 of the master cylinder 12 via the hydraulic passage 26 which is connected to the port PT12 and the port PT2. Further, the output chamber R12 is connectible with the accumulator 15b2 via the hydraulic passage 32 which is connected to the port PT13.

The third hydraulic pressure chamber R13 is defined by the cylinder body 15a1 and the rear end surface of the first large diameter portion 15a2a of the spool 15a2. The third hydraulic pressure chamber R13 is connectible with the reservoir 15b1 via the hydraulic passage 33 which is connected to the port PT14. A spring 15a3, which biases the third hydraulic pressure chamber R13 in a direction where the volume of the third hydraulic pressure chamber R13 increases, is disposed in the third hydraulic pressure chamber R13.

The spool 15a2 is formed by the first large diameter portion 15a2a, the second large diameter portion 15a2b and the small diameter portion 15a2c. The first large diameter portion 15a2a and the second large diameter portion 15a2b are configured to be liquid-tightly slidably movable within the cylinder body 15a1. The small diameter portion 15a2c is formed between the first large diameter portion 15a2a and the second large diameter portion 15a2b and is formed integrally therewith as a unit. The small diameter portion 15a2c is formed to have a diameter smaller than the first large diameter portion 15a2a and the second large diameter portion 15a2b. Further, a communication passage 15a5 which connects the output chamber R12 and the third hydraulic pressure chamber R13 is formed in the spool 15a2.

The pressure supply device 15b also serves as a drive portion which drives the spool 15a2. The pressure supply device 15b includes a reservoir 15b1 which is a low pressure source, an accumulator 15b2 which is a high pressure source that accumulates the brake liquid (corresponding to “fluid”), a pump 15b3 which pumps the brake liquid from the reservoir 15b1 into the accumulator 15b2 and an electric motor 15b4 which drives the pump 15b3. The reservoir 15b1 is exposed to the atmospheric pressure and the hydraulic pressure in the reservoir 15b1 is the same level with the atmospheric pressure. The pressure in the low pressure source is lower than the pressure in the high pressure source. The pressure supply device 15b is provided with a pressure sensor 15b5 which detects the pressure of the brake liquid supplied from the accumulator 15b2 and outputs the detected result to the brake ECU 17.

Further, the pressure supply device 15b is provided with a pressure decreasing valve 15b6 and the pressure increasing valve 15b7. In more detail, the pressure decreasing valve 15b6 is a normally open type electromagnetic valve which opens under a non-energized state. The flow-rate of the pressure decreasing valve 15b6 is controlled by the instructions from the brake ECU 17. One side of the pressure decreasing valve 15b6 is connected to the pilot chamber R11 via the hydraulic passage 31 and the other side thereof is connected to the reservoir 15b1 via the hydraulic passage 34. The pressure increasing valve 15b7 is a normally closed type electromagnetic valve which closes under a non-energized state. The flow-rate of the pressure increasing valve 15b7 is controlled by the instructions from the brake ECU 17. One side of the pressure increasing valve 15b7 is connected to the pilot chamber R11 via the hydraulic passage 31 and the other side thereof is connected to the accumulator 15b2 via the hydraulic passage 35 and the hydraulic passage 32 which is connected to the hydraulic passage 35.

The operation of the regulator 15a will be explained briefly hereinafter. In the case where the pilot pressure is not supplied to the pilot chamber R11 from the pressure decreasing valve 15b6 and the pressure increasing valve 15b7, the spool 15a2 is positioned at the initial position by means of a biasing force of the spring 15a3 (the state of FIG. 1). The initial position of the spool 15a2 is determined to a position to be fixed by the contact of the front end surface of the spool 15a2 with the restriction projecting portion 15a4. This initial position indicates the position immediately before the rear end surface of the spool 15a2 closes the port PT14.

As explained, when the spool 15a2 is in the initial position, the port PT14 and the port PT12 are in fluid communication with each other through the communication passage 15a5 and at the same time the port PT13 is closed by the spool 15a2.

In the case where the pilot pressure, which has been established in response to the brake pedal 11 operating amount by the operation of the pressure decreasing valve 15b6 and the pressure increasing valve 15b7, increases, the spool 15a2 moves in a rearward direction (right side in FIG. 1), overcoming the biasing force of the spring 15a3. The spool 15a2 moves to the position where the port PT13, which has been closed by the spool 15a2, opens. The port PT14 which has been in the open state, is closed by the spool 15a2. The position of the spool 15a2 under this state is defined to be the “pressure increasing position”. Under this state, the port PT 13 and the port PT 12 are in fluid communication with each other through the output chamber R12 (Pressure increasing operation).

By balancing the force between the pushing force at the front end surface of the second large diameter portion 15a2b2 of the spool 15a2 and a force corresponding to the servo pressure, the positioning of the spool 15a2 is determined. This position of the spool 15a2 is defined to be the “holding position”. At the holding position, the port PT13 and the port PT14 are closed by the spool 15a2. (Holding operation).

In the case where the pilot pressure which has been established in response to the brake pedal 11 operating amount by the operation of the pressure decreasing valve 15b6 and the pressure increasing valve 15b7, decreases, the spool 15a2 which has been in the holding position, now moves in a frontward direction by the biasing force of the spring 15a3. Then, the port PT13 which has been in the closed state by the spool 15a2 keeps the closed state. The port PT14 which has been in the closed state is open. The position of the spool 15a2 at this state is defined to be the “pressure decreasing position”. Under this state, the port PT14 and the port PT12 are in fluid communication with each other through the communication passage 15a5 (Pressure decreasing operation).

The above explained booster mechanism 15 establishes a pilot pressure in response to a stroke of the brake pedal 11 by the pressure decreasing valve 15b6 and the pressure increasing valve 15b7 and generates a servo pressure which responds to the stroke of the brake pedal 11 by the pilot pressure. The established servo pressure is supplied to the servo chamber R5 of the master cylinder 12 and the master cylinder 12 supplies the wheel cylinder WC with the master pressure generated in response to the stroke of the brake pedal 11. The pressure decreasing valve 15b6 and the pressure increasing valve 15b7 form a valve portion which adjusts the in-flow and out-flow of the brake liquid into or out of the servo chamber R5.

As explained, the vehicle braking device A according to the embodiment is formed by a by-wire type braking device. In other words, the vehicle braking device A is formed such that the adjustment of the master pressure can be performed independently of the operation of the brake pedal 11 (brake operating member) and the fluctuations of the master pressure do not directly influence on the brake pedal 11. In other words, the vehicle braking device A is configured such that under a normal operation state, excluding the case of electric failure, the brake pedal 11 is not structured to directly push the first master piston 12c.

The actuator 16 is a device which adjusts the brake hydraulic pressure to be applied to each wheel cylinder WC and a first conduit system 40 and a second conduit system 50 are provided.

The first conduit system 40 controls the brake hydraulic pressure to be applied to the front right wheel Wfr and the rear left wheel MI and the second conduit system 50 controls the brake hydraulic pressure applied to the front left wheel Wfl and the rear right wheel Wrr. In other words, the conduit system of this embodiment is an X-conduit (diagonal) system.

The hydraulic pressure supplied from the master cylinder 12 is transmitted to the respective wheel cylinders WC through the first and the second conduit systems 40 and 50. In the first conduit system 40, the hydraulic passage 40a is provided which connects the hydraulic passage 22 and the wheel cylinders WCfr and WCrl. In the second conduit system 50, the hydraulic passage 50a is provided which connects the hydraulic passage 24 and the wheel cylinders WCfl and WCrr. Through these hydraulic passages 40a and 50a, the hydraulic pressure supplied from the master cylinder 12 is transmitted to the wheel cylinders WC.

Each of the hydraulic passages 40a and 50a is branched to two passages, 40a1 and 40a2 and 50a1 and 50a2, respectively. In the branched hydraulic passages 40a1 and 50a1, the first pressure increasing control valves 41 and 51 which control increasing of the brake hydraulic pressure to the wheel cylinders WCfr and WCfl are disposed respectively and in the branched hydraulic passages 40a2 and 50a2, the second pressure increasing control valves 42 and 52 which control increasing of the brake hydraulic pressure to the wheel cylinders WCrl and WCrr, are disposed respectively.

These first pressure increasing control valves and the second pressure increasing control valves 41, 42, 51, 52 are formed by a two-position electromagnetic valve or a pressure differential control valve (linear valve) which can control the valve state to be a fluid communication state and an fluid interrupted state. The first pressure increasing control valves and the second pressure increasing control valves 41, 42, 51, 52 are formed as a normally open type valve which controls the valve state such that when the control current to the solenoid coil provided in the first pressure increasing control valves and the second pressure increasing control valves 41, 42, 51, 52 is zero value (non-energized state), the valve becomes in a fluid communication state and when the control current to the solenoid coil flows (energized state), the valve becomes in a fluid interrupted state. The master chambers R1 and R2 are connected to the wheel cylinders WC by means of the hydraulic passages 22, 24, 40a and 50a (corresponding to “hydraulic pressure passage”).

The hydraulic passage portion in each of the hydraulic passages 40a, 50a between the first and the second pressure increasing control valves 41, 42, 51, 52 and each wheel cylinder WC is connected to the reservoirs 43, 53 via the hydraulic passages 40b, 50b as the pressure decreasing hydraulic passages. In the hydraulic passage 40b, the pressure decreasing control valves 44, 45 formed by a two-position electromagnetic valve or a pressure differential control valve (linear valve) which controls the fluid communication state and fluid interrupted state are provided. Similarly, in the hydraulic passage 50b, the pressure decreasing control valves 54, 55 formed by a two-position electromagnetic valve or a pressure differential control valve (linear valve) which controls the fluid communication state and fluid interrupted state are provided. The pressure decreasing control valves 44 is disposed between the first pressure increasing control valve 41 and the reservoir 43. The pressure decreasing control valve 45 is disposed between the second pressure increasing control valve 42 and the reservoir 43. The pressure decreasing control valve 54 is disposed between the first pressure increasing control valve 51 and the reservoir 53. The pressure decreasing control valve 55 is disposed between the second pressure increasing control valve 52 and the reservoir 53. These pressure decreasing control valves 44, 45, 54, 55 are the normally closed type electromagnetic valves which become a fluid interrupted state when the control current to the solenoid coil provided in the respective pressure decreasing control valves is zero value (non-energized state) and become a fluid communication stat when the control current to the solenoid coil flows (energized state).

The hydraulic passages 40c and 50c, which are the return hydraulic passages, are provided between the reservoirs 43, 53 and the hydraulic passages 40a and 50a which are the main hydraulic passages. In the return hydraulic passages 40c and 50c, the pumps 46 and 56 are disposed which suction and/or discharge the brake liquid from the reservoirs 43, 53 side towards the master cylinder 12 side or towards the wheel cylinder WC side. The pump 46 discharges the brake liquid towards hydraulic passage 40a at the upstream side of the pressure increasing control valves 41, 42 (towards the master chamber R1 side). The pump 56 discharges the brake liquid towards the hydraulic passage 50a at the upstream side of the pressure increasing control valves 51, 52 (towards the master chamber R2 side). The pumps 46, 56 are driven by the motor 47. The pumps 46, 56 suction the brake liquid from the reservoirs 43, 53 and discharges the same to the hydraulic passages 40a, 50a thereby to supply (return) the master chambers R1 and R2 side with the brake liquid. In other words, the pumps 46, 56 pump up the brake liquid from the wheel cylinders WC to the master chambers R1 and R2 by driving.

The brake ECU 17 is structured such that the detection signals from the wheel speed sensor S which is provided at the vehicle wheel W. The brake ECU 17 calculates the wheel speed of each wheel W, a presumed vehicle speed and the slip ratio, etc., based on the detection signal from the wheel speed sensor S. The brake ECU 17 executes the ABS control (anti-skid control) based on the calculation result. It is noted that the target servo pressure (target master pressure) set in response to the brake operation or under various circumstances have a dead zone which has a certain width band.

Various controls using the actuator 16 are executed by the instructions from the brake ECU 17. For example, the brake ECU 17 outputs the control current that controls the various control valves 41, 42, 44, 45, 51, 52, 54 and 55 and the motor 47 which drives pumps provided in the actuator 16 to control the hydraulic pressure circuit in the actuator 16 to thereby independently control the wheel cylinder pressure which is the pressure in the wheel cylinder WC. The brake ECU 17 performs the ABS control which prevents the wheels from locking upon wheel being slipping, or about to be slipping during braking operation by controlling the actuator 16 to decrease, hold or increase the wheel cylinder pressure. The actuator 16 may be said to correspond to an ABS system (Anti-lock Brake System).

An example of the ABS control will be explained hereinafter, for example, in a case of controlling of the front right wheel Wfr. Under the pressure decreasing control in the ABS control, the first pressure increasing control valve 41 is controlled to be in a closed state and the pressure decreasing control valve 44 is controlled to be in an open state to thereby control the pump 46 to be driven. Then, the brake liquid in the wheel cylinder WCfr is introduced into the reservoir 43 through the pressure decreasing control valve 44 and the brake liquid in the reservoir 43 flows out to the upstream side (first master chamber R1 side) of the first pressure increasing control valve 41 through the pump 46. Since the first pressure increasing control valve 41 is in the closed state, the brake liquid pumped out from the pump 46 does not flow to the wheel cylinder WCfr side and accordingly, influences on the master pressure.

On the other hand, Under the pressure increasing control in the ABS control, the first pressure increasing control valve 41 is controlled to be in an open state (or in a differential pressure generating state: in a throttled state) and the pressure decreasing control valve 44 is controlled to be in a closed state. Under a holding control in the ABS control, both the first pressure increasing control 41 and the pressure decreasing control valve 44 are controlled to be in the closed state. The state that the ABS is operating is the state that the ABS control is being executed.

In summary, the vehicle braking device A is a by-wire type vehicle braking device which includes a master cylinder 12 which includes master pistons 12c and 12d and master chambers R1 and R2 the volumes of which are changeable in response to a movement of the master pistons 12c and 12d, a booster mechanism (driving portion) 15 which adjusts the master pressure which corresponds to the pressures in the master chambers R1 and R2 by driving the master pistons 12c and 12d, independently of the operation of the brake pedal (brake operating member) 11, an actuator 16 provided in a hydraulic passage (hydraulic pressure passage) 22, 24, 40a and 50a which connects the master chambers R1 and R2 and a plurality of wheel cylinders WC and adjusts a hydraulic pressure in each wheel cylinder WC and a brake ECU (control portion) 17 which controls the booster mechanism 15 and the actuator 16. The actuator 16 is configured to flow out the fluid towards the master chambers R1 and R2 side from a or some of the wheel cylinders WC which is the subject wheel cylinder for pressure decreasing operation of the wheel cylinder WC under the ABS control, when the ABS control is executed by the brake ECU 17.
(First Control and Second Control)

It is noted here that the brake ECU 17 is configured to (set to) execute the first control and the second control under a certain condition. The brake ECU 17 executes either the first control or the second control depending on the situation of ABS control of one or some of the wheels W among the plurality of wheels corresponding to the plurality of wheel cylinders WC.

The “first control” is a control which controls the booster mechanism 15 such that when the out-flow liquid amount (cc/s) of the brake liquid per unit time from the master chambers R1 and R2 is greater than a predetermined out-flow amount, comparing to a case where the out-flow liquid amount is equal to or less than the predetermined out-flow amount, the increasing amount of the master pressure per unit time during the pressure increasing operation of the master pressure becomes large or the decreasing amount of the master pressure per unit time during the pressure decreasing operation of the master pressure becomes small. The out-flow liquid amount can be said to be a flow-rate of the fluid out-flowing from the master chambers R1 and R2 to the actuator 16.

Further, the “second control” is a control which controls the booster mechanism 15 such that when the in-flow liquid amount (cc/s) of the brake liquid per unit time to the master chambers R1 and R2 is greater than a predetermined in-flow amount, comparing to a case where the in-flow liquid amount is equal to or less than the predetermined in-flow amount, the increasing amount of the master pressure per unit time during the pressure increasing operation of the master pressure becomes small or the decreasing amount of the master pressure per unit time during the pressure decreasing operation of the master pressure becomes large. The in-flow liquid amount can be said to be a flow-rate of the fluid in-flowing to the master chambers R1 and R2 from the actuator 16.

The first control can be said to be a control executed under a state that the ABS control is executed for only one or some of the wheels W and that the brake ECU 17 judges that the out-flow liquid amount of fluid from the master chambers R1 and R2 is larger than the predetermined out-flow liquid amount. Further, the second control can be said to be a control executed under a state that the ABS control is executed for only one or some of the wheels W and that the brake ECU 17 judges that the in-flow liquid amount of fluid to the master chambers R1 and R2 is larger than the predetermined in-flow amount. The brake ECU 17 may be said to include a judging portion which judges the magnitude relation of the flow amount.

The judgement explained above will be explained more concretely. According to the embodiment, the brake ECU 17 judges that the out-flow liquid amount is greater than the predetermined out-flow amount, when the control state of the actuator 16 to all of the front wheels Wf is a pressure increasing state and that the presumed pressure or the measured pressure of the wheel cylinders WCf of the front wheels Wf is less than a predetermined pressure. In other words, in such state, the first control is executed. The wheel cylinder pressure can be presumed by a well-known presumption (calculation) method, such as for example, presumed from the control state of booster mechanism 15 or the actual servo pressure (value of pressure sensor 26a), or from the control state of each electromagnetic valve of the actuator 16. The brake ECU 17 observes and knows the control state of each electromagnetic valve in the actuator 16. The predetermined pressure is set in advance. If the vehicle is equipped with pressure sensors which measure the respective wheel cylinder pressures, such measured pressure can be used for the judgement. It is noted that in the judgement, if the control state of the actuator 16 for at least one of the front wheels Wf is in the pressure increasing state and that the presumed pressure or the measured pressure of the wheel cylinder WCf of corresponding front wheel Wf is less than the predetermined pressure, it is judged that the out-flow liquid amount is greater than the predetermined out-flow amount.

Regarding to the wheel cylinder WC, the relation between the flow-rate and the pressure is confirmed already in advance and generally, the smaller the pressure, the larger the flow-rate necessary for raising the pressure becomes. In other words, the smaller the wheel cylinder pressure, the larger the in-flow liquid amount to the wheel cylinder WC easily becomes. Accordingly, it is judged that the out-flow liquid amount is greater than the out-flow amount when the presumed pressure of the wheel cylinder WC (may be also referred to as “presumed wheel cylinder pressure”) is less than the predetermined pressure.

Further, the brake ECU 17 judges also that the out-flow liquid amount is greater than the predetermined out-flow amount when the presumed in-flow liquid amount per unit time to the wheel cylinder WC to which the ABS control is executed is greater than a predetermined value. In other words, in this case, also, the first control is executed. The in-flow liquid amount (cc/s) to the wheel cylinder WC can be presumed by a well-known presumption (calculation) method, such as for example, presumed from the control state of each electromagnetic valve of the actuator 16, the control state of the booster mechanism 15 or the measured value of the servo pressure and a presumed wheel cylinder pressure (or the measured wheel cylinder pressure). The brake ECU 17 makes the judgment by comparing the calculated presumed in-flow liquid amount with the predetermined value set in advance.

Further, the brake ECU 17 judges that the in-flow liquid amount is greater than the predetermined in-flow amount when the ejected amount (cc/s) of the brake liquid per unit time ejected by the pumps 46 and 56 is greater than a predetermined elected amount. In other words, in this case the second control is executed. Since the brake ECU 17 controls the driving operation of the pumps 46 and 56, the brake ECU 17 can confirm the ejected amount of the brake liquid per unit time ejected by the pumps 46 and 56.

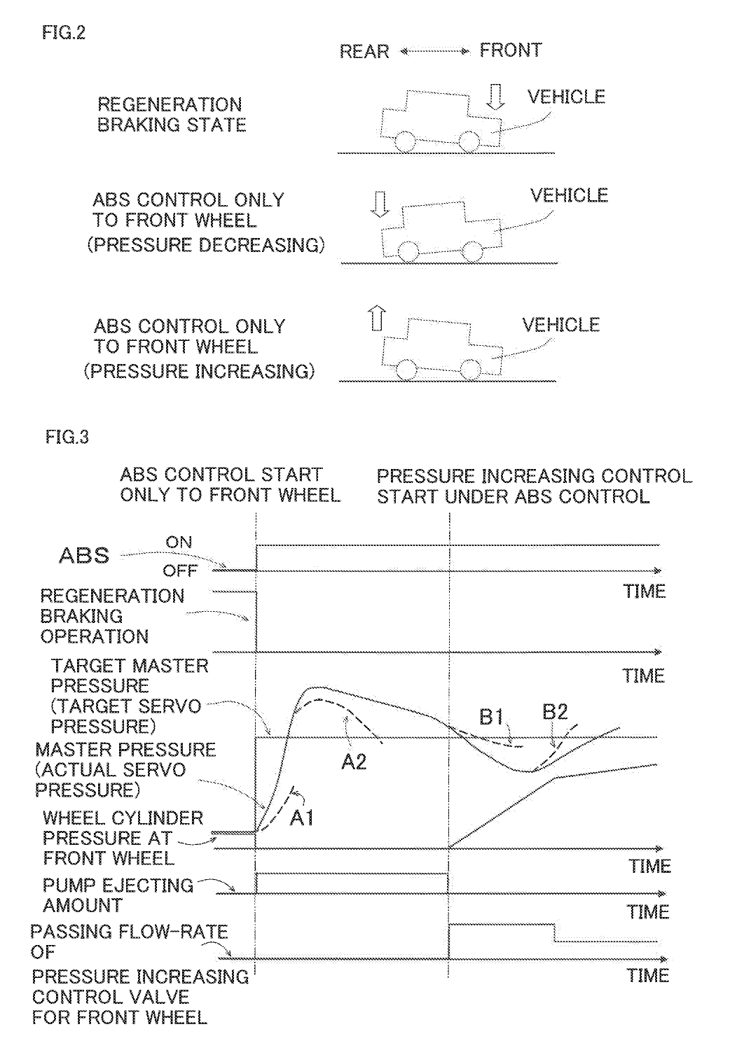

Hereinafter, the first and the second controls will be explained by raising a concrete control example. First, a case that neither the first control nor the second control is executed will be explained. As shown at the upper portion in FIG. 2, when the brake operation starts, a regeneration braking operation is initiated by the regeneration braking device B. In this case, almost all of the required barking force (values corresponding to the brake operation) are covered by the regeneration barking force and accordingly, the use of hydraulic pressure braking force generated by the wheel cylinder pressure is substantially zero. The brake ECU 17 controls the master pressure by the booster mechanism 15 so that the difference (insufficient braking force) between the required braking force and the regeneration braking force is appropriated by the hydraulic pressure braking force. In this example, the master pressure becomes substantially zero (atmospheric pressure). However, the master pressure is not necessarily zero. Under this situation, the braking force applied to the front wheel Wf is the sum of the regeneration braking force and the master pressure (=wheel cylinder pressure). Further, the braking force applied to the rear wheel Wr corresponds to the hydraulic pressure braking force (=wheel cylinder pressure). Under this situation, the vehicle becomes a front loaded state (state where the front side of the vehicle is submerged).

Then, as shown at middle portion in FIG. 2, when the ABS control is executed only to the front wheel Wf, the regeneration braking force is released and the master pressure (for example, a hydraulic pressure which exerts the hydraulic pressure braking force equal to or the same with the regeneration braking force) which has been adjusted by the booster mechanism 15 is supplied to the wheel cylinder WC. Under such state, the pressure decreasing control is performed to the wheel cylinder WCf of the front wheel Wf and the master pressure is not supplied to the wheel cylinder WCf to thereby eject the fluid in the wheel cylinders WCf to the master chamber R1 and R2 side by the operation of the pumps 46 and 56. The master pressure under this state is the sum of the hydraulic pressure adjusted by the booster mechanism 15 and exerting the hydraulic pressure braking force which is equal to or the same with the regeneration braking force and an increased pressure worth increased based on the ejected amount of brake liquid ejected by the pumps 46 and 56. The state of the wheel cylinder pressure at the front wheel Wf is kept to the pressure decreased state until the slipping of vehicle wheel recovers. On the other hand, the state of the wheel cylinder pressure at the rear wheel Wr becomes the master pressure. In other words, the braking force at the rear wheel Wr suddenly becomes greater than the braking force at the front wheel Wf and the vehicle becomes a rear loaded state (state where the rear side of the vehicle is submerged).

Next, as shown at the lower portion in FIG. 2, when only the front wheel Wf is under ABS control, the brake ECU 17 executes a pressure increasing control to the wheel cylinder WCf to apply braking force in response to the road surface condition (in response to the friction coefficient on the road surface). Thus, the brake liquid in the master chambers R1 and R2 flows into the wheel cylinder WC of the front wheel Wf to decrease the master pressure corresponding thereto. This pressure decreasing operation of the master pressure makes the braking force at the rear wheel Wr to drop and the vehicle again becomes the front loaded state. As explained, when the ABS control is executed only to a portion of the wheel W (in this case, the front wheel Wf), the vehicle has a tendency of making pitching in a front/rear direction and an improvement with respect to the stability of the vehicle behavior is still needed.

It is noted here that hereinafter, the explanation of the case where the first and the second controls are executed will be made. As shown in FIG. 3, when the ABS control is performed only to the front wheel Wf and the regeneration braking force operation stops, in order to output the regeneration braking force worth of the hydraulic pressure braking force, the master pressure is increased by the booster mechanism 15 and at the same time the pressure decreasing control to the front wheel Wf is executed. At this time, the brake ECU 17 monitors the ejected amount of the pumps 46, 56, and executes the second control when the ejected amount per unit time is greater than a predetermined ejected amount.

As shown with the dotted line A1 in FIG. 3, the second control, in the case of pressure increasing control of the master pressure, is a control which changes the control amount of the booster mechanism 15 such that the increase amount of the master pressure per unit time (inclination of pressure increasing) is changed in a reducing direction. In this embodiment the control amount corresponds to the in- and out-flow amount of the brake liquid with respect to the servo chamber R5.

The control of the master pressure (servo pressure) by the booster mechanism 15 is performed by the combination of the feed-back control and the feed-forward control and for example, performed by PID control (Proportional Integral Derivative Controller). The flow-rate Q of the fluid flowing into the servo chamber R5 increases as the difference ΔP between the target servo pressure (target master pressure) and the actual servo pressure (value of the pressure sensor 26a) becomes large. The flow-rate Q is for example, set by the value (Q=Kₚ×ΔP+K_{D}×Z1+K_{I}×Z2). In this formula, the values of Kₚ, K_{D} and K_{I} are the set coefficient values, Z1 indicates the servo pressure change amount (differential value) and Z2 indicates the servo pressure integrated value. In the second control where the master pressure is under pressure increasing control, for example, the value Kₚ is set to be smaller than the set value (initial value). In other words, the brake ECU 17 switches over the feedback gain to a smaller value (set value of the second control) which is smaller than a value at normal control operation. Therefore, the flow-rate Q becomes small compared to the case that second control is not being performed and the increasing amount of the master pressure per unit time becomes smaller.

Further, as shown with the dotted line A2 in FIG. 3, the second control, in the case of pressure decreasing control of the master pressure, is a control which changes the control amount of the booster mechanism 15 such that the decrease amount of the master pressure per unit time (inclination of pressure decreasing) is changed in an increasing direction. For example, the brake ECU 17 switches over the set coefficient (for example, feedback gain) (for example, to a larger value) by performing the second control and controls the booster mechanism 15 such that the decreasing amount of the master pressure per unit time becomes large, larger than a value at normal control operation. Therefore, the decreasing amount of the master pressure per unit time becomes larger than a case where the second control is not being performed.

Consequently, under the ABS control at the front wheel Wf, control is changed from the pressure decreasing control to the pressure increasing control, and the first and the second pressure increasing control valves 41 and 42 are in the open state. Under this situation, when the presumed in-flow liquid amount (cc/s) per unit time flowing into the wheel cylinder WCf is larger than a predetermined value or the presumed wheel cylinder pressure of the front wheel Wf is less than a predetermined pressure, the brake ECU 17 executes the first control. The presumed in-flow liquid amount may be a passing flow-rate of fluid per unit time passing through the first and the second pressure increasing control valves 41 and 42.

As shown with the dotted line B1 in FIG. 3, the first control in the case of pressure decreasing control of the master pressure is a control which changes the control amount of the booster mechanism 15 such that the decrease amount of the master pressure per unit time (inclination of pressure decreasing) is changed in a decreasing direction. As similar to the case of the second control, the brake ECU 17 switches over the set coefficient (for example, feedback gain) (for example, to a smaller value) and controls the booster mechanism 15 such that the decreasing amount of the master pressure per unit time becomes small, smaller than a value at normal control operation. Therefore, the decreasing amount of the master pressure per unit time becomes smaller than a case where the first control is not being performed.

Further, as shown with the dotted line B2 in FIG. 3, the first control, in the case of pressure increasing control of the master pressure, is a control which changes the control amount of the booster mechanism 15 such that the increase amount of the master pressure per unit time (inclination of pressure increasing) is changed in an increasing direction. As similar to the case of the second control, the brake ECU 17 switches over the set coefficient (for example, feedback gain) (for example, to a larger value) and controls the booster mechanism 15 such that the increasing amount of the master pressure per unit time becomes large, larger than a value at normal control operation. Therefore, the increasing amount of the master pressure per unit time becomes larger than a case where the first control is not being performed.

In other words, the first control can be said that an instruction to strengthen the pressure increasing operation (instruct the valve to further open) is sent to the pressure increasing valve 15b7 during the master pressure increasing operation and that an instruction to weaken the pressure decreasing operation (instruct the valve to further close) is sent to the pressure decreasing valve 15b6 during the master pressure decreasing operation. Further, the second control can be said that an instruction to weaken the pressure increasing operation (instruct the valve to further close) is sent to the pressure increasing valve 15b7 during the master pressure increasing operation and that an instruction to strengthen the pressure decreasing operation (instruct the valve to further open) is sent to the pressure decreasing valve 15b6 during the master pressure decreasing operation. It is noted that the first control and the second control explained above as an example, do not change the target master pressure (target servo pressure).

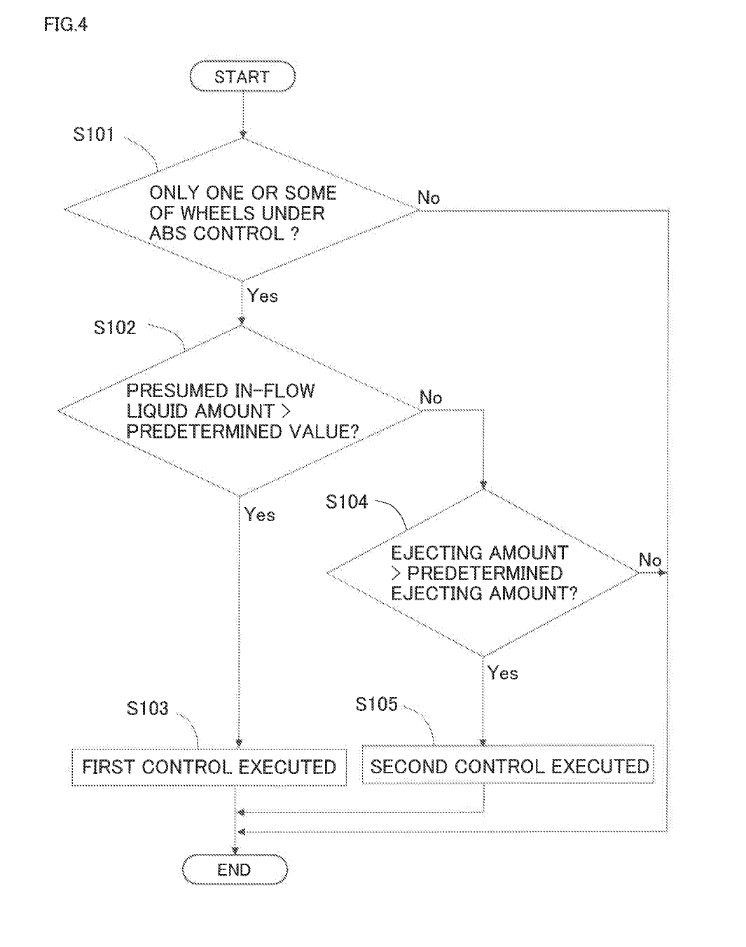

An example of the flow of control will be explained hereinafter with reference to FIG. 4. The brake ECU 17 judges whether or not the control state is the state that ABS control is being executed only to one or some of the wheels W (S101). If the control state is judged to be the state that the ABS control is being executed only to the one or some of the wheels W (S101; Yes), the brake ECU 17 judges whether or not the presumed in-flow liquid amount of fluid per unit time of the wheel cylinder WC to which the ABS control is executed is larger than a predetermined value (S102). If the presumed in-flow liquid amount is judged to be larger than the predetermined value (S102; Yes), the brake ECU 17 executes the first control according to the control state of the master pressure (S103).

On the other hand, if the presumed in-flow liquid amount is judged to be equal to or less than the predetermined value (S102; No), the brake ECU 17 judges whether or not the ejecting amount of fluid per unit time by the pumps 46, 56 is greater than a predetermined ejecting amount (S104). If the ejecting amount is greater than the predetermined ejecting amount, (S104; Yes), the brake ECU 17 executes the second control according to the control state of the master pressure (S105).

If all of the wheels “W” are under execution of ABS control, or none of the wheels “W” are under execution of ABS control (S101; No), or the ejecting amount of fluid is equal to or less than the predetermined ejecting amount (S104; No), the first control and the second control are not executed and execution of normal control is kept continuing. The brake ECU 17 can executes the above control flow per every predetermined time. It is noted that the first control and the second control are stopped, for example, when the execution condition is cancelled and the set coefficient returns to the normal value.
(Effect)

According to the embodiment, by suppressing the pressure increase of the master pressure or by enhancing the pressure decrease of the master pressure by the execution of the second control, the raise of master pressure caused by the pumping back phenomenon during the ABS control can be suppressed. Accordingly, a sudden raise of braking force at the non-ABS controlled rear wheel Wr can be avoided to suppress an occurrence of transitional braking force imbalance (for example, transition of vehicle state from front loaded to rear loaded state). In other words, according to the second control, the stability of vehicle posture can be improved. Further, according to the embodiment, by suppressing the pressure decrease of the master pressure or by enhancing the pressure increase of the master pressure by the execution of the first control, the drop of master pressure caused by the increase of flow-rate to the wheel cylinders WC to which the ABS control is executed can be suppressed. Accordingly, a drop of braking force at the rear wheel Wr can be avoided to suppress an occurrence of transitional braking force imbalance (for example, transition of vehicle state from rear loaded to front loaded state). In other words, the stability of vehicle posture can be improved also by the first control. As explained, according to the embodiment, the increase or decrease of the master pressure caused by the ABS control to one or some of the wheels can be suppressed and this can eventually contribute to the improvements in vehicle stability during braking operation.

Further, according to the embodiment, the timing of execution of the first control is judged based on the presumed pressure of the wheel cylinder pressure or the presumed in-flow liquid amount and the timing of execution of the second control is judged based on the ejecting amount of fluid by the pumps 46 and 56. Thus, the first and the second controls are executed at an appropriate timing in response to the current state.

Further, since the vehicle according to the embodiment is a hybrid vehicle which generates a regeneration braking force to the front wheel Wf, initial behavior of vehicle by the braking operation tends to make the vehicle to be in a front loaded state and further, since the initial ABS control is executed only to the front wheel Wf, the vehicle behavior shown in FIG. 2 tends to be generated. Further, according to this vehicle, it is necessary to increase the master pressure greatly after the regeneration braking operation is released and upon this situation, the behavior shown in FIG. 2 tends to be generated. Accordingly, the first control and the second control according to the embodiment are particularly very effective to the vehicle equipped with a regeneration braking device. In other words, the embodiment of the invention is further effective to the vehicle which is capable of generating a regenerative braking force and further more effective to the vehicle which is equipped with a regeneration braking device which applies the regeneration braking force to the front wheel Wf. It is noted however, even a vehicle with no such regeneration braking device can suppress the generation of imbalance of transitional braking force caused by the pressure increase or decrease of master pressure upon ABS controlling to one or some of the wheels W, as long as a master chamber common to (when a master chamber is divided into a plurality of chambers, if such chambers are mechanically inter-connected, such chambers may be said to be one master chamber) a plurality of wheel cylinders WC according to the embodiment. Therefore, the stability of vehicle behavior can be improved for such vehicle by performing the first and the second controls.
(Others)

The present invention is not limited to the embodiment explained above, but may include a structure wherein the booster mechanism 15 does not have the regulator 15a. The booster mechanism 15 is, for example, configured to have the pressure increasing valve connected to the high pressure source and the pressure decreasing valve connected to the low pressure source for controlling the fluid in the servo chamber R5. Further, the booster mechanism 15 may be a booster mechanism which drives the first master piston 12c by control and may be configured by a motor and a ball screw, etc., which drives the first master piston 12c by being driven by the motor. In such configuration, the control amount of the motor (ball screw displacement amount) corresponds to the in and out-flow of fluid (controlled flow-rate) into or out of the servo chamber R5.

Further, the first control may be set such that the target servo pressure (target master pressure) is raised temporarily and the second control may be set such that the target servo pressure (target master pressure) is dropped temporarily. Still further, the brake ECU 17 may be set such that the brake ECU 17 may execute only one of the first and the second controls. This invention is applicable to a vehicle which is not equipped with a regeneration braking device.

Further, the “out-flow liquid amount of brake liquid per unit time flowing out of the master chambers R1 and R2” may be set to the integrated amount (integrated value) of fluid flowing out of the master chambers R1 and R2 after the ABS control started. The judgment may be made based on such integrated amount of fluid. The predetermined out-flow amount may be set based on the integrated value. Similarly, the “in-flow liquid amount of brake liquid per unit time flowing into the master chambers R1 and R2” may be set to the integrated amount (integrated value) of fluid flowing into the master chambers R1 and R2 after the ABS control started. The judgment may be made based on such integrated amount of fluid. The predetermined in-flow amount may be set based on the integrated value. It may be said that the out-flow liquid amount per unit time and in-flow liquid amount per unit time may, as a meaning, include conceptually the integrated amount.

Further, the judgement of the second control execution may be based on the condition of “during pressure decreasing control in ABS control and when the ejection amount is greater than a predetermined ejection amount”. For example, when the pumps are always operated with a constant rotation speed during the ABS control, the ejecting amount of the pumps 46 and 56 become constant when the fluid supply source exists and accordingly, the ejecting amount may be presumed (judged) by judging whether the pressure decreasing control valves 44, 45, 54, 55 are closed or not (whether or not the control is under pressure decreasing control). In other words, the magnitude of the ejecting amount can be judged whether or not the wheel cylinder WC is under a fluid supply source state.

### REFERENCE SIGNS LIST

11; brake pedal (brake operating member), 12: master cylinder, 12c: first master piston, 12d: second master piston, 15; booster mechanism (driving portion), 16; actuator, 46, 56: pump, 17; brake ECU (control portion), “A”; vehicle braking device, R1: first master chamber, R2: second master chamber, R5; servo chamber, W: vehicle wheel, WC; wheel cylinder.

1. A vehicle braking device of a by-wire type comprising:
a master cylinder having a master piston and a master chamber which volume is changed in response to a movement of the master piston;
a driving portion which drives the master piston to adjust a master pressure which is a pressure of the master chamber independently of an operation of a brake operating member;
an actuator provided in a hydraulic passage connecting the master chamber and a plurality of wheel cylinders for adjusting a hydraulic pressure in each of the plurality of wheel cylinders; and
a control portion which controls the driving portion and the actuator, wherein
the actuator is configured to flow out a fluid in a pressure decreasing subject wheel cylinder among the plurality of wheel cylinders to flow towards the master chamber upon pressure decreasing control for the pressure decreasing subject wheel cylinder under an ABS control execution when the ABS control is executed by the control portion; and
under the ABS control being executed at only one or some of a plurality of vehicle wheels corresponding to the plurality of wheel cylinders,
the control portion executes a first control which controls the driving portion such that if an out-flow liquid amount of the fluid per unit time from the master chamber is greater than a predetermined out-flow amount, an increasing amount of the master pressure per unit time under a pressure increasing control of the master pressure becomes great or a decreasing amount of the master pressure per unit time under a pressure decreasing control of the master pressure becomes small, compared to a case where the out-flow liquid amount is equal to or less than the predetermined out-flow amount and/or
the control portion executes a second control which controls the driving portion such that if an in-flow liquid amount of the fluid per unit time into the master chamber is greater than a predetermined in-flow amount, the increasing amount of the master pressure per unit time under the pressure increasing control of the master pressure becomes small or the decreasing amount of the master pressure per unit time under the pressure decreasing control of the master pressure becomes great, compared to a case where the in-flow liquid amount is equal to or less than the predetermined in-flow amount.

2. The vehicle braking device according to claim 1, wherein,
the control portion judges that the out-flow liquid amount is greater than the predetermined out-flow amount when a control state of the actuator to at least one of front wheels is a pressure increasing state and at the same time when a presumed pressure or a measured pressure of the at least one of the front wheels is less than a predetermined pressure.

3. The vehicle braking device according to claim 1, wherein,
the control portion judges that the out-flow liquid amount is greater than the predetermined out-flow amount when a presumed in-flow liquid amount per unit time to the wheel cylinders to which the ABS control is executed is larger than a predetermined value.

4. The vehicle braking device according to claim 1, wherein
the actuator includes a pump which pumps up the fluid from the wheel cylinder to the master cylinder by driving; and wherein
the control portion judges that in-flow liquid amount is greater than a predetermined in-flow amount when an ejecting amount of fluid per unit time by the pump is larger than a predetermined ejecting amount.
